(19) United States
(12) Patent Application Publication
(10) Pub. No.: US 2026/0003177 A1
(43) Pub. Date: Jan. 1, 2026

(54) CONTROL APPARATUS, MEASUREMENT APPARATUS, CONTROL METHOD, AND STORAGE MEDIUM

(71) Applicant: CANON KABUSHIKI KAISHA, Tokyo (JP)

(72) Inventor: AKIRA EGUCHI, Tochigi (JP)

(21) Appl. No.: 19/248,070

(22) Filed: Jun. 24, 2025

(30) Foreign Application Priority Data
Jun. 28, 2024 (JP) 2024-105394

(51) Int. Cl. G02B 21/24; G01B 9/04; G01B 11/24; G02B 21/00; G02B 27/64

(52) U.S. Cl. CPC G02B 21/244; G01B 9/04; G01B 11/24; G02B 21/0032; G02B 21/245; G02B 27/646

(57) ABSTRACT

A control apparatus includes at least one memory storing instructions, and at least one processor that, upon execution of the instructions, is configured to acquire a first image by imaging using an imaging unit and first information on a region corresponding to a sample in the first image, the first image including the sample acquired at a position defocused by a first amount from an in-focus position, and acquire shape information on a shape of the sample based on the first information and the first amount.

### BACKGROUND

### Field of the Technology

The present disclosure relates to a control apparatus configured to acquire information on the shape of a transparent sample (test material).

### Description of the Related Art

In cell culture, information on the shape of the cell, such as its size and shape, is an important index of cell activity and growth, and is to be properly acquired. Since cells are generally colorless and transparent, it is necessary to observe transparent samples. U. Agero, L. G. Mesquita, B. R. A. Neves, R. T. Gazzinelli, and O. N. Mesquita, “Defocusing microscopy,” Microscopy research and technique, Vol. 65, No. 3, pp. 159-165, 16 Dec. 2004, U.S.A. discloses a configuration that utilizes the property in which when light with a phase distribution propagates, an intensity distribution corresponding to the phase distribution appears, and observes a colorless and transparent sample with high contrast at a defocus position.

### SUMMARY

A control apparatus according to one aspect of the present disclosure includes at least one memory storing instructions, and at least one processor that, upon execution of the instructions, is configured to acquire a first image by imaging using an imaging unit and first information on a region corresponding to a sample in the first image, the first image including the sample acquired at a position defocused by a first amount from an in-focus position, and acquire shape information on a shape of the sample based on the first information and the first amount. A measurement apparatus having the above control apparatus, a control method corresponding to the above control apparatus, and a storage medium storing a program that causes a computer to execute the above control method also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a measurement apparatus according to one embodiment of the present disclosure.

FIG. 2 is a schematic diagram of a sample in Examples 1 and 2.

FIGS. 3A and 3B explain positive and negative defocuses.

FIG. 4 illustrates an image acquired in Example 1.

FIG. 5 illustrates a relationship between a defocus amount and a diameter of a bright part in Example 1.

FIG. 6 illustrates a relationship between an estimated diameter and a true diameter in Example 1.

FIG. 7 is a flowchart illustrating a method for measuring a sample in Example 1.

FIG. 8 is a flowchart illustrating a method for measuring a sample in Example 2.

FIG. 9 illustrates a relationship between an estimated diameter and a true diameter in Example 2.

FIG. 10 is a schematic diagram of a sample in Example 3.

FIG. 11 illustrates an image acquired in Example 3.

FIG. 12 illustrates a relationship between lengths of estimated major and minor axes and lengths of true major and minor axes in Example 3.

FIG. 13 is a schematic diagram of a sample in Example 4.

FIG. 14 illustrates an image acquired in Example 4.

FIG. 15 is a schematic diagram illustrating a method for estimating a shape of a sample in Example 4.

FIG. 16 is a flowchart illustrating a method for measuring a sample in Example 4.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the disclosure. Corresponding elements in respective figures will be designated by the same reference numerals, and a duplicate description thereof will be omitted.

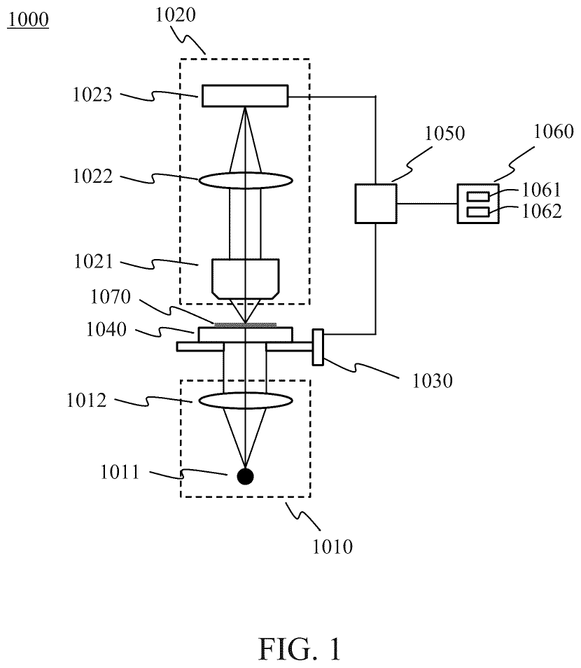

FIG. 1 is a schematic diagram of a measurement apparatus 1000 according to one embodiment of the present disclosure. The measurement apparatus 1000 includes an illumination unit 1010, an imaging unit 1020, a focus change unit 1030, a sample holder 1040, a control unit 1050, and a calculator 1060. In the measurement apparatus 1000, a sample 1070 is illuminated by illumination light emitted from the illumination unit 1010, and the imaging unit 1020 acquires an image using light that has transmitted through the sample 1070. The measurement apparatus 1000 is a transmission type microscope in this embodiment, but it may be a reflection type microscope using light reflected by the sample.

The illumination light emitted from the illumination unit 1010 may be approximately spatially coherent. As an example of a configuration for this purpose, the illumination unit 1010 includes a light source 1011 and an illumination optical system 1012. An LED, a laser light source, or the like can be used as the light source 1011. It is also possible to guide light from an LED or laser through an optical fiber and use the end of the optical fiber as the light source 1011. A general lens can be used as the illumination optical system 1012. This embodiment also functions in a configuration in which the illumination optical system 1012 is not included and light from the light source 1011 is directly applied to the sample 1070.

The imaging unit 1020 includes an objective lens 1021, an imaging lens 1022, and an image sensor 1023. A magnified image of the sample 1070 formed by the objective lens 1021 and the imaging lens 1022 is converted into image data by the image sensor 1023. In order to acquire images at different magnifications, the objective lens 1021 may be attached to a revolver in which a plurality of objective lenses can be installed.

The focus change unit 1030 is an electromotive stage or the like that can drive the sample holder 1040 in the optical axis direction, and is used to change the focus state. As long as the focus state can be changed in imaging the sample 1070, an electromotive stage capable of driving the entire imaging unit 1020 in the optical axis direction, or an electromotive stage that drives the image sensor 1023 in the optical axis direction, etc. may be used. An optical system or optical element for changing the focus state may be provided in the imaging unit 1020.

The sample holder 1040 is a sample stage that is used in general microscopes, etc. and is not particularly limited as long as it is configured to hold or place the sample 1070.

The control unit 1050 is connected to the imaging unit 1020 and the focus change unit 1030, and controls the change of defocus, the acquisition of images, etc.

The calculator 1060 includes a first acquiring unit 1061 and a second acquiring unit 1062. The first acquiring unit 1061 acquires an image (first image) including the sample 1070 acquired at a position (defocus position) defocused from an in-focus position by a defocus amount (first amount) from the control unit 1050. The first acquiring unit 1061 acquires an evaluation amount (first information) for a region (first region) corresponding to the sample 1070 in the acquired image. The evaluation amount is, for example, information indicating a contour such as a plurality of pieces of coordinate information indicating a contour of the first region, or information indicating a diameter of the first region such as the diameter of the first region itself or a distance between peaks of light intensity in the first region. The region corresponding to the sample 1070 includes a blur amount based on the imaging unit 1020, and a bright part or a dark part is used as described later. The second acquiring unit 1062 acquires (estimates) information (shape information) on the shape of the sample 1070 based on the first information and the defocus amount. In this embodiment, the information on the shape of the sample 1070 is information corresponding to an evaluation amount (second information) regarding a region (second region) corresponding to the sample of an image (second image) including the sample 1070 acquired at a position closer to the in-focus position than a defocus position. The information corresponding to the second information may be the second information itself, or may be information after the blur amount based on the imaging unit 1020 included in the second information has been corrected. More specifically, the information on the shape of the sample 1070 may be, for example, information indicating the contour, such as a plurality of pieces coordinate information indicating the contour of the second region, or information indicating the diameter of the second region, such as the diameter of the second region itself or the distance between peaks of light intensity in the second region. The calculator 1060 may be, for example, a calculation apparatus (control apparatus) such as a computer or a workstation. The control unit 1050 and the calculator 1060 may be integrated. The calculator 1060 may be a calculation system prepared on the cloud, or may be connected to the control unit 1050 or the imaging unit 1020, etc., through a communication unit such as the Internet. The calculator 1060 may have not only a calculation processing function, but also functions such as data storage and display.

The sample 1070 may be, for example, a transparent biological sample, such as a cell or tissue slice. This embodiment is particularly effective for cells in culture, but is applicable not only to biological samples, but also to transparent objects with a size or structure of about 1 μm to 100 μm, such as microbeads made of polystyrene or silica.

### Example 1

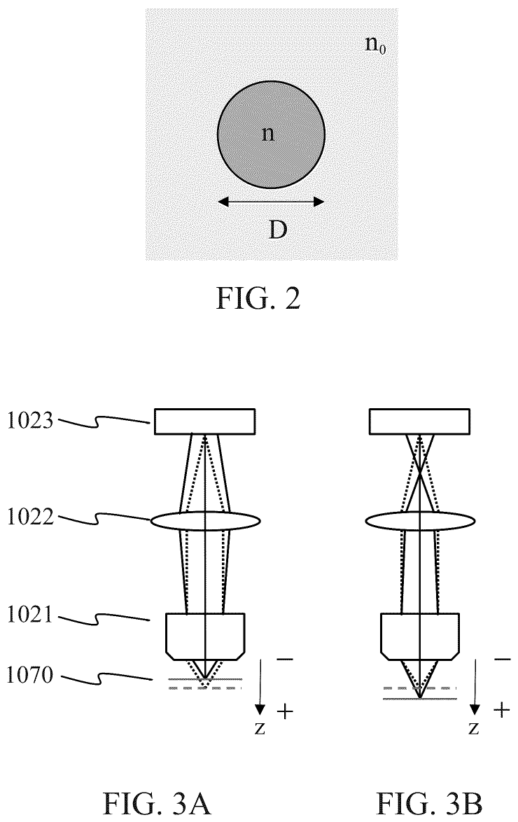

A measurement method according to this example will be described using a simulation. For simple description purposes, consider a spherical sample with a refractive index of n and a diameter of D in a medium with a refractive index of no, as illustrated in FIG. 2, as an example of sample 1070. The wavelength of light emitted from the illumination unit 1010 is 2, the numerical aperture of objective lens 1021 is NA, and the magnification of the imaging unit 1020 is M. Images of the sample 1070 acquired by the imaging unit 1020 are simulated at a plurality of defocus positions.

The sign of defocus will now be described with reference to FIGS. 3A and 3B. FIGS. 3A and 3B explain the positive and negative of the defocus. In FIGS. 3A and 3B, a dotted line indicates an optical path in an in-focus state, and a solid line indicates an optical path in a defocus state. FIG. 3A illustrates a case where the defocus is negative, in a direction in which the sample 1070 approaches the objective lens 1021 and the imaging position is located behind the image sensor 1023. FIG. 3B illustrates a case where the defocus is positive, in a direction in which the sample 1070 moves away from the objective lens 1021 and the imaging position is located in front of the image sensor 1023. The same definition can be used in a case where defocus is given by moving the image sensor 1023 or the imaging unit 1020. For example, in a case where the image sensor 1023 is moved, the image sensor 1023 approaches the imaging lens 1022, the imaging position is located behind the image sensor 1023 as in FIG. 3A, and the state becomes a negative defocus state. An amount by which the sample 1070 moves along the optical axis from the in-focus state is defined as z. In this disclosure, z will be referred to as a defocus amount. Even when the image sensor 1023 is moved, the defocus amount can be similarly defined from the imaging relationship.

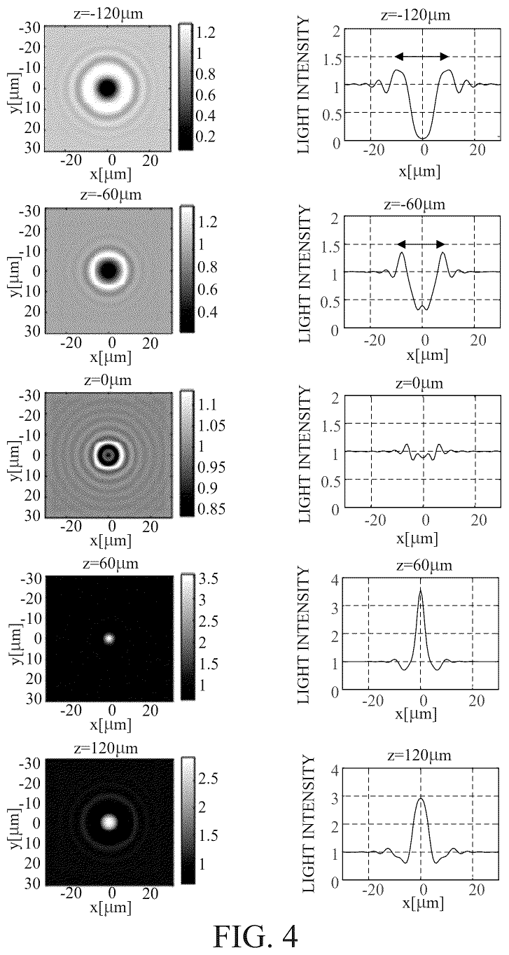

FIG. 4 illustrates images acquired in this example. FIG. 4 (left part) illustrates images acquired by changing a defocus amount z where the refractive index n₀ is 1.33, the refractive index n is 1.34, the diameter D is 10 μm, the wavelength λ is 0.53 μm, the numerical aperture NA is 0.12, and the magnification M is 1. In order to make it easier to understand the changes in the light and dark shapes that appear in the images, a luminance range of the image in FIG. 4 (left part) is adjusted for each image. FIG. 4 (right part) illustrates a section for each image in FIG. 4 (left part) at y of 0. A light and dark ring pattern can be seen at the in-focus position (z=0), but the contrast is very small as illustrated in the sections of FIG. 4 (right part).

Generally, it is difficult to perform image processing using an image near an in-focus position with low contrast, because images contain optical shot noise, dark current noise, and false patterns caused by the container for housing sample. At negative defocus (z<0), a bright area with high light intensity, illustrated in white, appear as rings, and the contrast is higher than that of the image at the in-focus position. This example estimates the diameter of the sample from the ring-shaped bright part.

The diameter of the bright part relates to the diameter D of the sample 1070, but as illustrated in FIG. 4, the bright part also expands as the defocus amount z increases, and the diameter of the sample 1070 cannot be estimated by detecting the spread of the bright part alone. In addition, since an image is acquired through an optical system, the image also contains the blur of the optical system. This example estimates the diameter of the sample by removing the spread of the bright part due to defocus and the spread due to the blur of the optical system.

First, the spread caused by defocus is separated. The diameter Dw of the bright part is acquired from the image acquired at each defocus position. This example simply acquires a distance between peaks in the one-dimensional section indicated by an arrow in FIG. 4 (right part) as the diameter Dw of the bright part. The method of acquiring the diameter Dw is not limited to this example, and can perform calculations such as extracting the contour of the bright part by performing binarization processing or differentiation processing for the image and acquiring the diameter.

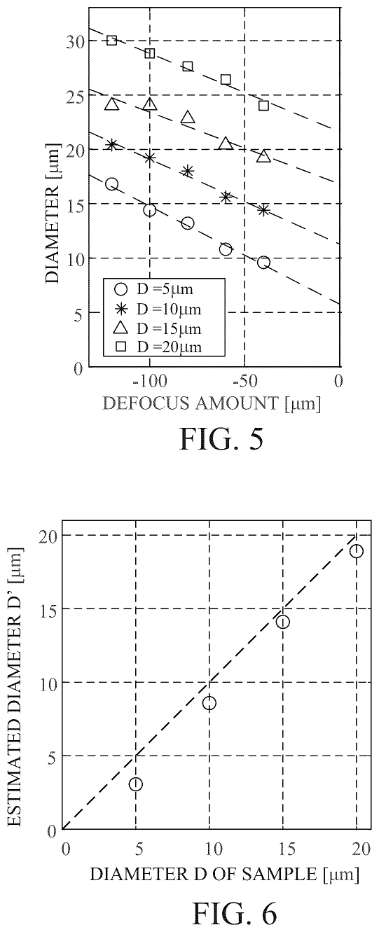

FIG. 5 illustrates a relationship between the defocus amount z and the diameter Dw of the bright part. For any sample diameter, the diameter Dw increases as the defocus increases. Conversely, the influence of the spread caused by the defocus can be eliminated by extrapolating the diameter Dw(0) at a defocus amount z of 0 from the acquired diameter Dw(z). This example fits the diameter Dw(z) acquired at each defocus position with a linear function to the defocus amount z, and acquires the diameter Dw(0) at a defocus amount z of 0 from the acquired approximation line (broken line in FIG. 5).

The diameter Dw(0) includes the spread due to the blur caused by the objective lens 1021 and the imaging lens 1022. The spread that an aberration-free optical system has at the in-focus position is known as an Airy disc, and its radius Ra is expressed by the following equation (1):

$$Ra = 0.61 λ / NA \qquad ( 1 )$$

In this example, the width of the bright part corresponds to the radius. This example acquires a distance between the peak positions of the bright parts as the diameter Dw, and thus estimates a value acquired by subtracting the radius Ra from the diameter Dw(0) as estimated diameter D′ of the sample 1070.

FIG. 6 illustrates a relationship between the estimated diameter D′ and the true diameter D. In FIG. 6, a “circle” indicates the estimated diameter D′, and a broken line is a straight line indicating the true diameter D. The estimated diameter D′ is acquired so as to follow the broken line. In other words, the diameter of the sample 1070 can be properly acquired by the method according to this example.

This example acquires the diameter of the bright part acquired for negative defocus, but is not limited to this example. As illustrated in FIG. 4 (left part), a dark part with low light intensity appears in a ring shape for positive defocus, so the diameter of the sample 1070 may be estimated from this diameter. However, with positive defocus, a strong intensity appears near the center, and it becomes difficult to adjust the luminance during imaging. In some cases, an image may not be able to be accurately acquired due to luminance saturation, etc. Therefore, an image may be acquired for negative defocus and the diameter may be estimated from the bright part that appears in the image.

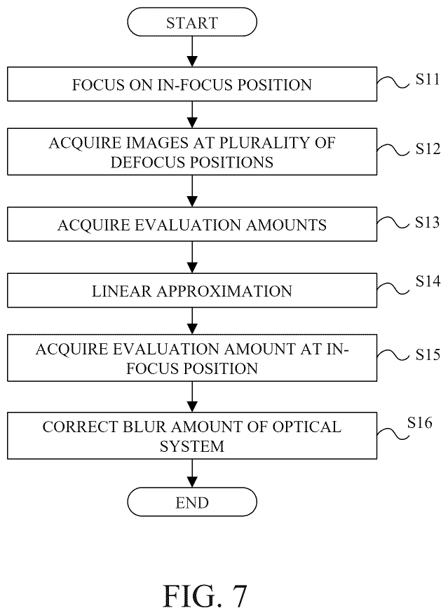

Referring now to FIG. 7, a description will be given of a measurement method of the sample 1070 based on the above principle. FIG. 7 is a flowchart illustrating the measurement method of the sample 1070 in this example.

In step S11, the control unit 1050 focuses on the sample 1070 held in the sample holder 1040 via the focus change unit 1030 according to an instruction from the user. More specifically, the user executes the processing of this step by causing the control unit 1050 to drive the focus change unit 1030 while an in-focus index, such as contrast, acquired from the image data sent from the image sensor 1023 is monitored. The processing of this step may be automatically performed by the control unit 1050.

In step S12, first, the focus change unit 1030 moves the sample 1070 in the optical axis direction, and the image sensor 1023 acquires image data at each defocus position.

The calculator 1060 acquires images at a plurality of defocus positions. A defocus position that is used for the measurement is out of focus, and it is sufficient that a defocus amount z is given that provides a high contrast so that the shape can be acquired by image processing.

The defocus amount z [μm] may satisfy the following inequality (2):

$$10 \leq \vert z \vert \leq 3000 \qquad ( 2 )$$

In a case where |z| is lower than the lower limit of inequality (2), it is difficult to obtain high contrast for biological samples such as cells in nutrient solution. On the other hand, in a case where |z| is higher than the upper limit of inequality (2), the bright or dark area may spread too much and overlap the bright or dark area from another sample.

Inequality (2) may be replaced with inequality (2a) below:

$$25 \leq \vert z \vert \leq 900 \qquad ( 2 a )$$

Inequality (2) may be replaced with inequality (2b) below:

$$1 \; 00 \leq \vert z \vert \leq 300 \qquad ( 2 b )$$

The processing of this step may be performed automatically by the control unit 1050.

In step S13, the calculator 1060 obtains an evaluation amount regarding a bright or dark area that is a region corresponding to the sample 1070 of the image acquired in step S12. For the sample 1070 that is assumed to have a spherical shape, such as floating cells or microbeads, the contour of the circular bright area that appears in the image is extracted, and its diameter is acquired as the evaluation amount. Alternatively, an evaluation amount such as a diameter may be acquired by acquiring the distance between peaks in the light intensity without extracting the contour.

In step S14, the calculator 1060 linearly approximates the evaluation amount with respect to the defocus amount. A linear function is the simplest function, and the linear approximation may satisfactorily reproduce the change in the evaluation amount due to defocus. However, this example is not necessarily limited to a linear function, and approximation may use a polynomial.

In step S15, the calculator 1060 acquires an evaluation amount at the in-focus position from the acquired approximation line. This step may acquire a value of the approximation line when the defocus amount z is 0. The essence of this step is to eliminate the influence of the spread due to defocus by predicting the evaluation amount at a position closer to the in-focus position than a position where the measurement was performed from the evaluation amount acquired at a position other than the in-focus position. The predicted value may be acquired using machine learning such as a neural network that has been previously trained rather than using an approximation function. However, a method using a linear function that has a small calculation load and can be executed by general-purpose processing is the most useful method in practice.

In step S16, the calculator 1060 corrects a blur amount of the optical system from the evaluation amount acquired in step S15. As described above, in a case where a distance between peaks of the bright part for negative defocus is used as the evaluated value, the correction can be made by subtracting the Airy radius Ra from the distance. When the diameter of the circle that depicts the outside of the bright part is used as the evaluated value, the correction should be twice the Airy radius Ra, and when the diameter of the circle that depicts the inside of the bright part is used as the evaluated value, the correction can be eliminated. The correction amount is properly changed depending on the method of obtaining the evaluated value. The processing of step S16 may be performed before step S14 or S15. In a case where the user determines that the accuracy of the evaluation amount acquired in the processing of step S15 is sufficient, there is no need to execute the processing of step S16.

### Example 2

A measurement method according to this example will be described using a simulation. Similarly to in Example 1, this example assumes a spherical sample illustrated in FIG. 2 as the sample 1070.

As illustrated in FIG. 5, the spread of the bright area that appears for negative defocus does not depend on the diameter of the spherical sample, and changes with approximately the same slope with respect to the defocus amount z. In other words, the evaluation amount at the in-focus position can be predicted using the slope acquired from the evaluation amount acquired at a single defocus position by previously acquiring a change amount (slope in linear approximation) of the evaluation amount for the bright area with respect to the defocus amount z by a simulation or the like.

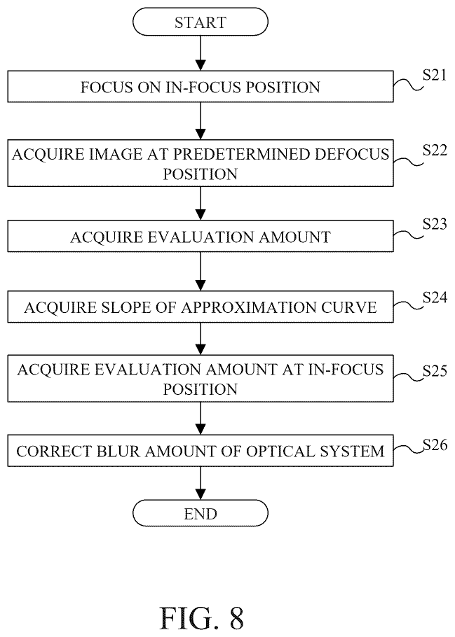

The measurement method of the sample 1070 based on the above principle will be described with reference to FIG. 8. FIG. 8 is a flowchart illustrating the measurement method of the sample 1070 according to this example.

The processing of step S21 is similar to the processing of step S11, and thus a description thereof will be omitted.

In step S22, the calculator 1060 acquires an image at a predetermined defocus position. The processing of this step is performed by moving the sample 1070 in the optical axis direction using the focus change unit 1030 and by acquiring image data using the image sensor 1023 at the predetermined defocus position. The defocus position for measurement may be a single position in a range of 40 μm≤|z|≤1 mm described in step S12. The processing of this step may be automatically performed by the control unit 1050.

The processing of step S23 is similar to the processing of step S13, and thus a description thereof will be omitted.

In step S24, the calculator 1060 reads a slope m of an approximation line that approximates the evaluation amount and defocus amount previously acquired. In a case where the evaluation amount and defocus amount are approximated by a nonlinear function, a coefficient that determines the approximation function is read.

In step S25, the calculator 1060 acquires the evaluation amount Dw(0) at the in-focus position from the measured evaluation amount Dw(z) and the slope m of the read approximation line. In the linear approximation, it can be acquired using the equation Dw(0)=Dw(z)−mz. In the nonlinear approximation function, calculations can be performed according to each function to obtain the evaluation amount at the in-focus position. As described in Example 1, the processing in this step is one means of removing the influence of the spread due to defocus contained in the evaluation amount. The evaluation amount at the in-focus position may be predicted using machine learning such as a neural network that has been previously trained. It is not necessary to be at an exact in-focus position, and in a case where the evaluation amount is acquired at a position closer to the in-focus position than the defocus position at which the image was acquired, the influence of the spread due to defocus can be reduced.

The processing in step S26 is similar to the processing in step S16, and thus a description thereof will be omitted. The processing in step S26 may be performed before step S24 or S25. In a case where the user determines that the accuracy of the evaluation amount acquired in the processing in step S25 is sufficient, the processing in step S26 may be omitted.

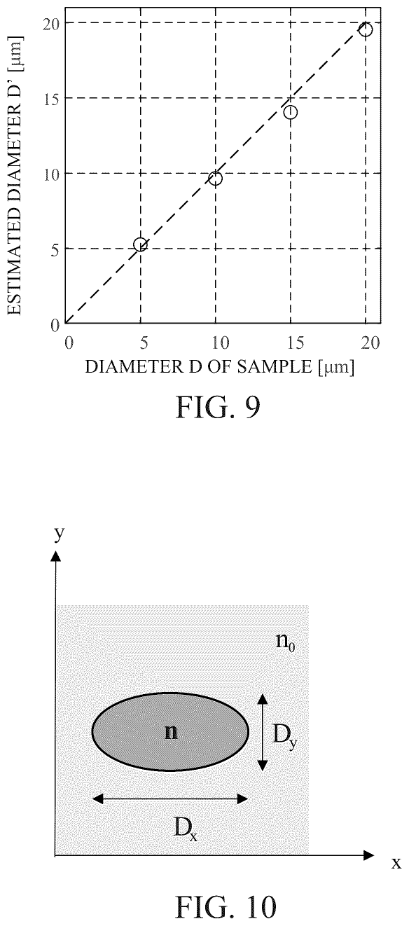

FIG. 9 illustrates a relationship between the estimated diameter D′ estimated from the bright area that appears in an image acquired with a defocus amount z of −100 μm and the true diameter D. In FIG. 9, an average value of the slope of the approximation curve acquired in a case where the true diameter D of the sample 1070 in Example 1 is 5 to 20 μm is used as a predicted slope m. In FIG. 9, the “circle” indicates the estimated diameter D′, and the broken line is a straight line indicating the true diameter D. The estimated diameter D′ is acquired so as to follow the broken line. In other words, the diameter of the sample 1070 can be properly acquired by the method according to this example.

### Example 3

A measurement method according to this example will be explained using a simulation. This example assumes an ellipsoid sample illustrated in FIG. 10 as the sample 1070. In this example, the sample 1070 has a major axis in the x direction and a rotationally symmetric shape with respect to the x direction. In this example, the major axis length and minor axis length of the ellipse are acquired as evaluation amounts.

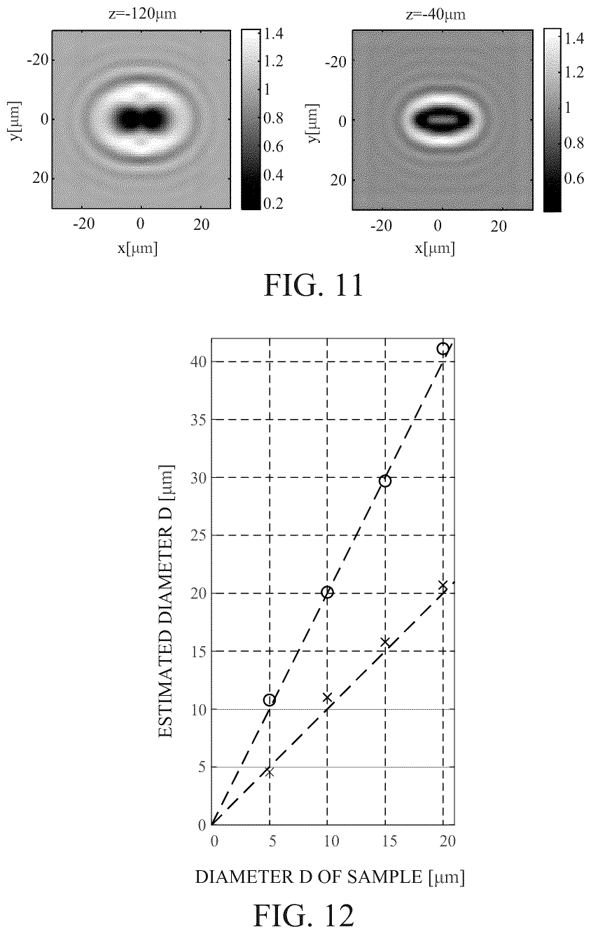

FIG. 11 illustrates images acquired in this example, which are obtained with an internal refractive index n of 1.34, a medium refractive index n₀ of 1.33, a major axis length Dx of 20 μm, a minor axis length Dy is 10 μm, and defocus amounts z of −40 μm and −120 μm. In FIG. 11, a ring-shaped bright area appears, as in the result for the sphere illustrated in FIG. 5, but FIG. 11 reflects the fact that the sample 1070 is an ellipsoid, the bright area has an elliptical shape. Similarly to the case of a sphere, the elliptical shape of the bright area spreads by increasing the defocus amount. Therefore, by acquiring the lengths in the x and y directions of the elliptical bright area as evaluation amounts and performing processing according to the flowchart in FIG. 7, the lengths in the x and y directions of the sample 1070 can be acquired.

FIG. 12 illustrates a relationship between estimated major axis length Dx′ and minor axis length Dy′ and true major axis length Dx and minor axis length Dy. In FIG. 12, the circle and cross indicate the major axis length Dx′ and the minor axis length Dy′, respectively, and the broken line is a straight line indicating the true value. The estimated length is acquired along the broken line. In other words, the method according to this example can properly acquire the major axis length and the minor axis length of the sample 1070. This method can also acquire the ellipticity by calculating a ratio of the major axis length to the minor axis length.

### Example 4

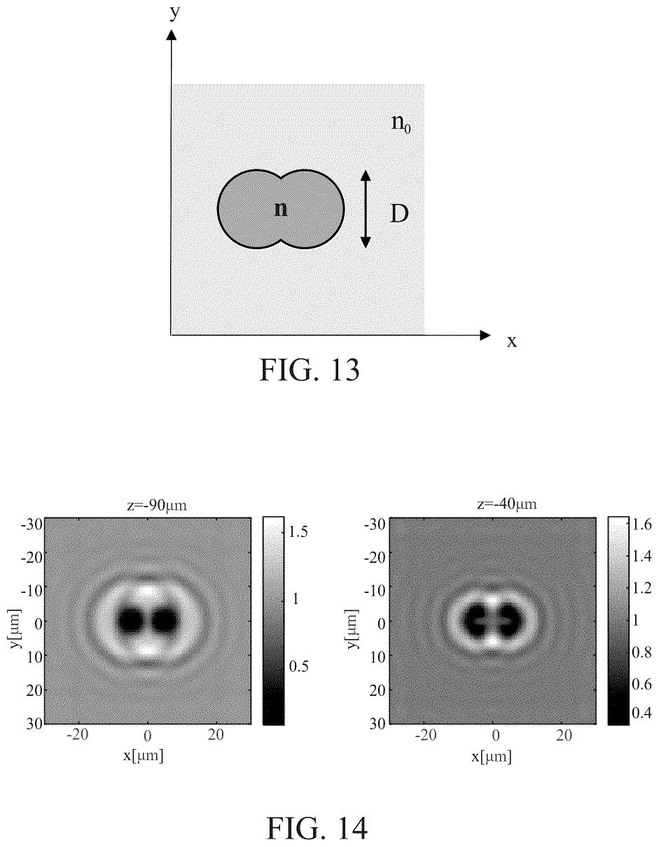

This example will discuss a method of estimating information that represents the shape itself, rather than information about the shape of the sample, as an evaluation amount. As an example of the sample 1070, this example assumes a shape in which two spheres with diameter D illustrated in FIG. 13 are partially joined.

FIG. 14 illustrates images acquired in this example, which are obtained with an internal refractive index n of 1.34, a medium refractive index n₀ of 1.33, a diameter D of one sphere of 10 μm and defocus amounts z of −40 μm and −90 μm. As in the results illustrated in FIGS. 4 and 11, bright areas reflecting the contour of the sample 1070 appear, and spread as the defocus amount is increased. In other words, the same phenomenon occurs not only for the symmetrical shapes of Examples 1 and 3, but also for an arbitrary transparent sample.

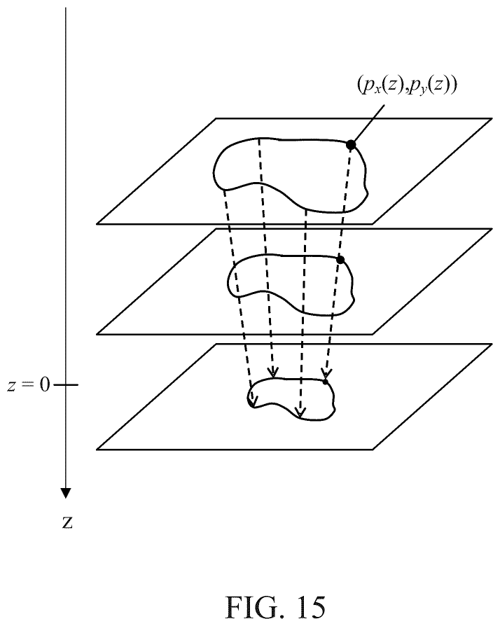

The principle of estimating the shape of the sample 1070 will be described with reference to FIG. 15. FIG. 15 is a schematic diagram illustrating a method of estimating the shape of the sample 1070 in this example. pₓ(z) and p_{y}(z) are an x-coordinate and a y-coordinate on the contour of a bright or dark area that appears in an image with a predetermined defocus amount z. The coordinates pₓ(z) and p_{y}(z) represent all coordinates detected on the contour of a bright or dark area, and do not represent one coordinate. The contours of bright and dark areas may be extracted using the position where the light intensity is locally maximum, a contour determined by edge extraction, or coordinates determined as a result of determining and fitting a shape such as a circle or ellipse. The coordinates pₓ(z) and p_{y}(z) change depending on the defocus amount z, but from the simulation results so far, they change linearly with the absolute value |z|. Therefore, from pₓ(z) and p_{y}(z) extracted from images acquired with a plurality of defocus amounts z, the defocus amount z can be approximated with a linear function, as illustrated by a dotted line in FIG. 15. In a case where the coordinates pₓ(0) and p_{y}(0) representing the contour at the in-focus position are acquired from the linear function, the contour of sample 1070 can be acquired. However, the coordinates pₓ(z) and p_{y}(z) extracted from the image are different from the contour of the sample 1070 due to the blur caused by the optical system. As described in Example 1, in a case where the position where the light intensity in the image is locally maximized is extracted as pₓ(z) and p_{y}(z), it will be estimated to be larger by the size of the Airy radius Ra. Thus, the shape of the sample 1070 can be set to a shape smaller by the Airy radius Ra than the estimated shape.

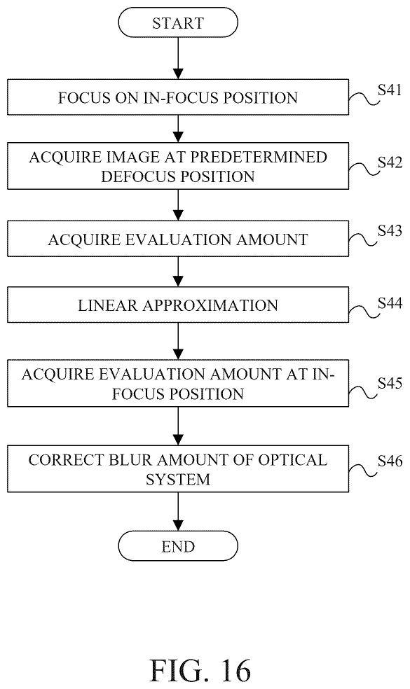

A method for measuring the sample 1070 based on the above principle will now be described with reference to FIG. 16. FIG. 16 is a flowchart illustrating a method for measuring the sample 1070 in this example.

Steps S41 to S42 are similar to steps S11 and S22, respectively, and thus a description thereof will be omitted.

In step S43, the calculator 1060 acquires the coordinates pₓ(z) and p_{y}(z) representing the contour of a bright or dark area from the captured image. The method for extracting the contours of bright and dark areas is not particularly limited.

In step S44, the calculator 1060 linearly approximates the coordinates pₓ(z) and p_{y}(z) representing the contour of a bright or dark area with a defocus amount. This approximation does not necessarily have to be a linear function, and may use a polynomial.

In step S45, the calculator 1060 acquires the coordinates pₓ(0) and p_{y}(0) representing the contour at the in-focus position from the acquired approximation straight line. Similarly to Example 1, the essence of this step is to eliminate the influence of spread due to defocus by predicting the evaluation amount at a position closer to the in-focus position than the position where the measurement was performed from the contours pₓ(z) and p_{y}(z) acquired at a position other than the in-focus position. The approximation is not necessary to use a linear function, and prediction may be made by machine learning or the like.

In step S46, the calculator 1060 corrects a blur amount of the optical system from the predicted contours pₓ(0) and p_{y}(0). As described above, this step may acquire a shape that is reduced by the Airy radius Ra. The processing of this step may be performed before step S44 or S45. In a case where the user determines that the accuracy of the evaluation amount acquired in the processing of step S45 is sufficient, the processing of step S46 may be omitted.

As described above, the configuration according to this example can predict the shape of the sample itself, as well as a specific evaluation amount indicating the shape such as the diameter. Once the shape of the sample is determined, the evaluation amount can be obtained in terms of the diameter, major axis length, etc., and thus the acquisition of the evaluation amount is one application example in measuring the shape of the sample. However, the more complex the shape of the sample is, the more different the contour shape of the original sample and the bright or dark areas become due to the influences of diffraction and overlap between samples. Therefore, each example may measure the shape of single-layer tissue pieces or cells, well-dispersed microbeads, etc.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a control apparatus that can acquire information on a shape of a transparent sample with high accuracy.

This application claims priority to Japanese Patent Application No. 2024-105394, which was filed on Jun. 28, 2024, and which is hereby incorporated by reference herein in its entirety.

What is claimed is:

1. A control apparatus comprising:
at least one memory storing instructions; and
at least one processor that, upon execution of the instructions, is configured to:
acquire a first image by imaging using an imaging unit and first information on a region corresponding to a sample in the first image, the first image including the sample acquired at a position defocused by a first amount from an in-focus position, and
acquire shape information on a shape of the sample based on the first information and the first amount.

2. The control apparatus according to claim 1, wherein execution of the stored instructions further configures the at least one processor is configured to:
estimate, based on the first information and the first amount, second information on a region corresponding to the sample in a second image including the sample acquired at a position defocused by a second amount smaller than the first amount, and
wherein the shape information corresponds to the second information.

3. The control apparatus according to claim 2, wherein the second information is information indicating a diameter of a region corresponding to the sample in the second image.

4. The control apparatus according to claim 2, wherein the first information is information indicating a diameter of the region corresponding to the sample in the first image, and
wherein the shape information is information indicating the diameter of the sample.

5. The control apparatus according to claim 2, wherein the second information is information indicating a contour of the region corresponding to the sample in the second image.

6. The control apparatus according to claim 5, wherein the first information is information indicating the contour of the region corresponding to the sample in the first image, and
wherein the shape information is information indicating the contour of the sample.

7. The control apparatus according to claim 2, wherein the second information is information on the region corresponding to the sample in the second image acquired at the in-focus position.

8. The control apparatus according to claim 2, wherein execution of the stored instructions further configures the at least one processor to acquire the shape information by correcting a blur amount based on the imaging unit included in the second information.

9. The control apparatus according to claim 1, wherein execution of the stored instructions further configures the at least one processor to:
acquire a plurality of first images acquired at a plurality of defocus positions distant from the in-focus position by a plurality of different defocus amounts, by imaging using the imaging unit,
acquire a plurality of pieces of first information corresponding to the plurality of first images, and
acquire the shape information based on the plurality of pieces of first information and the plurality of defocus amounts.

10. The control apparatus according to claim 9, wherein execution of the stored instructions further configures the at least one processor to:
find a function expressing a relationship between the plurality of pieces of first information and the plurality of defocus amounts by utilizing fitting of a linear function, and
acquire the shape information based on the function.

11. The control apparatus according to claim 10, wherein the function is a polynomial using the plurality of defocus amounts and the first information, and
wherein the first information represents a diameter of the region.

12. The control apparatus according to claim 1, wherein the at least one processor is configured to:
find a coefficient that determines a function expressing a relationship between the first information and the first amount by utilizing fitting of a linear function, and
acquire the shape information based on the function.

13. The control apparatus according to claim 12, wherein the function is a polynomial using the first information and the first amount.

14. The control apparatus according to claim 1, wherein the at least one processor is configured to:
acquire the shape information using machine learning based on the first information and the first amount.

15. The control apparatus according to claim 1, wherein the first image is acquired at a negative defocus position.

16. The control apparatus according to claim 1, wherein the first amount is determined by according to satisfaction of an inequality:
$$10 \leq \vert z \vert \leq 3000$$
where z [μm] is the first amount.

17. A measurement apparatus comprising:
the control apparatus according to claim 1;
the illumination unit configured to illuminate the sample;
the imaging unit configured to image the sample; and
a focus change unit configured to change a focus state of the sample relative to the imaging unit.

18. A control method configured to control a measurement apparatus that includes an illumination unit configured to illuminate a sample and an imaging unit for imaging the sample, the control method comprising:
acquiring a first image by imaging using the imaging unit and first information on a region corresponding to the sample in the first image, the first image including the sample acquired at a position defocused by a first amount from an in-focus position, and
acquiring shape information on a shape of the sample based on the first information and the first amount.

19. A non-transitory computer-readable storage medium storing a program that causes a computer to execute a control method configured to control a measurement apparatus that includes an illumination unit configured to illuminate a sample and an imaging unit for imaging the sample,
wherein the control method includes:
acquiring a first image by imaging using the imaging unit and first information on a region corresponding to the sample in the first image, the first image including the sample acquired at a position defocused by a first amount from an in-focus position, and
acquiring shape information on a shape of the sample based on the first information and the first amount.
